(19) United States
(12) Patent Application Publication
(10) Pub. No.: US 2010/0086750 A1
(43) Pub. Date: Apr. 8, 2010

(54) CONDUCTIVE POLYMER METAMATERIALS

(75) Inventors: Girsh Blumberg, New Providence, NJ (US); Aref Chowdhury, Berkeley Heights, NJ (US)

Correspondence Address: HITT GAINES, PC;ALCATEL-LUCENT, PO BOX 832570, RICHARDSON, TX, 75083, US

(73) Assignee: Lucent Technologies Inc., Murray Hill, NJ (US)

(21) Appl. No.: 12/247,819

(22) Filed: Oct. 8, 2008

(51) Int. Cl. B32B 3/10; B32B 27/00; H04B 10/00

(52) U.S. Cl. 428/195.1; 428/500; 398/118

(57) ABSTRACT

An apparatus 100, comprising an optical component 105 having a stack 180 of layers 182 of electrically conductive flexible polymers, the stack being a metamaterial.

### CROSS REFERENCE RELATED APPLICATION

The present application is related to U.S. patent application Ser. No. ______ (Docket No. Chowdhury 24-12) to Chowdhury, et al., entitled “Chirped Metamaterial Antennas”, which is commonly assigned with the present application and hereby incorporated by reference as if reproduced herein in its entirety.

### TECHNICAL FIELD OF THE INVENTION

The invention is directed, in general, to optical systems and, more specifically, to an optical system comprising a metamaterial that includes electrically conductive flexible polymers.

### BACKGROUND OF THE INVENTION

There is much interest in artificial structures that have metamaterials properties because such structures can have unusual optical properties. Artificially-constructed metamaterials are typically metal-containing composites with sub-wavelength features that impart the metamaterial's optical properties. The practical application of metallic metamaterials in optical systems has been in part limited by difficulties in constructing these sub-wavelength metallic features with the appropriate precision and low-cost. For instance metallic components may require extensive machining, and, the final structure may be fragile and inflexible.

### SUMMARY OF THE INVENTION

To overcome the above-described limitations, one embodiment is an apparatus, comprising an optical component having a stack of layers of electrically conductive flexible polymers, the stack being a metamaterial.

Another embodiment is a method of use. The method comprises providing providing a optical component having a stack of layers of electrically conductive flexible polymers, the stack being a metamaterial. The further comprises changing an optical property of the optical component by flexing the metamaterial optical component.

Another embodiment is a method of manufacture. The method comprises forming a optical component including forming a stack of layers of electrically conductive flexible polymers, the stack being a metamaterial.

### BRIEF DESCRIPTION OF THE DRAWINGS

The embodiments of the disclosure are best understood from the following detailed description, when read with the accompanying FIGUREs. Corresponding or like numbers or characters indicate corresponding or like structures. Various features may not be drawn to scale and may be arbitrarily increased or reduced in size for clarity of discussion. Reference is now made to the following descriptions taken in conjunction with the accompanying drawings, in which:

FIGS. 1A, 1B and 1C show perspective views of three example systems of the disclosure;

FIGS. 2A and 2B present a flow diagrams of selected steps of an example methods of use of the disclosure, e.g., such as using the systems in FIGS. 1A, 1B, and 1C; and

FIGS. 3A and 3B present flow diagrams of selected steps of an example method of manufacture of the disclosure, e.g., such as manufacturing the systems in FIGS. 1A, 1B and 1C.

### DETAILED DESCRIPTION

A metamaterial optical component that includes or is made of an electrically conductive flexible polymer has advantages compared metamaterials made of metal. The use of electrically conductive flexible polymers allows the shape of the metamaterial to be changed, thereby changing the optical properties of the optical component. Thus, a change in optical property can be made without having to re-machine or reassemble the optical component, as could be the case if the metamaterial was made of metal.

There can be other advantages in using metamaterials that include electrically conductive polymers. Generally, polymers are less dense than metals, and therefore, the overall weight of a metamaterial structure made from electrically conductive polymers can be substantially lower than the equivalent structures made with metal. There are methods of forming polymers into sub-wavelength feature patterns that are not as readily available for metal. In some cases, the electrical conductive properties of the polymers can be modulated by environmental changes that would otherwise not affect the electrical conductive properties of a metal.

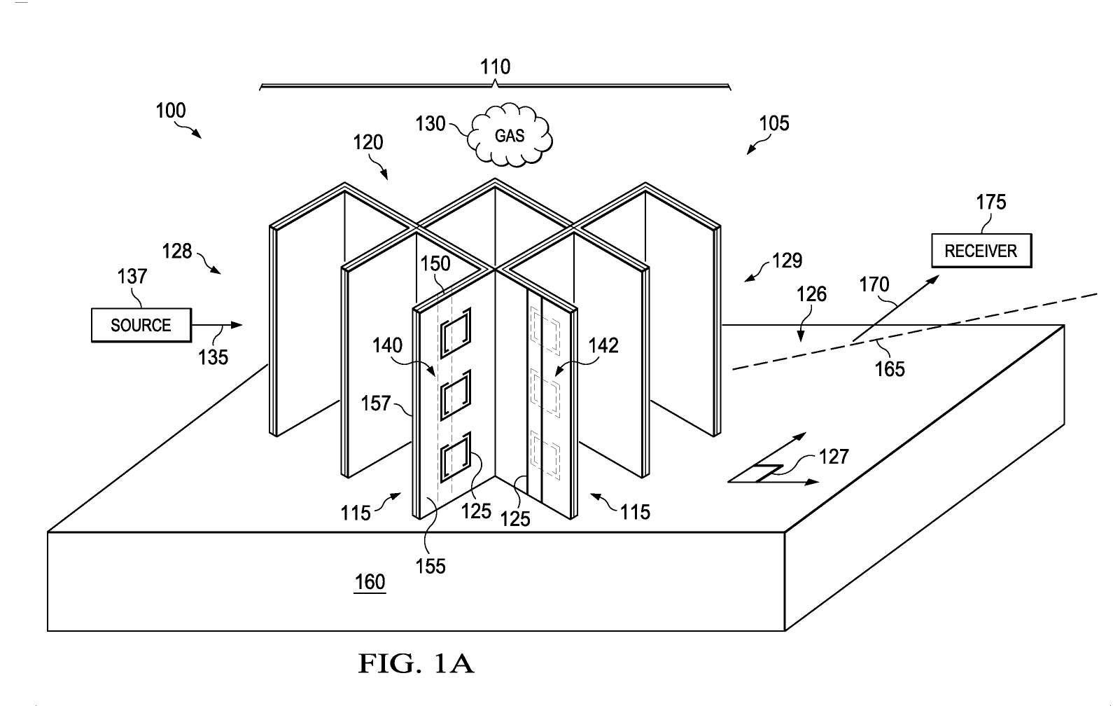

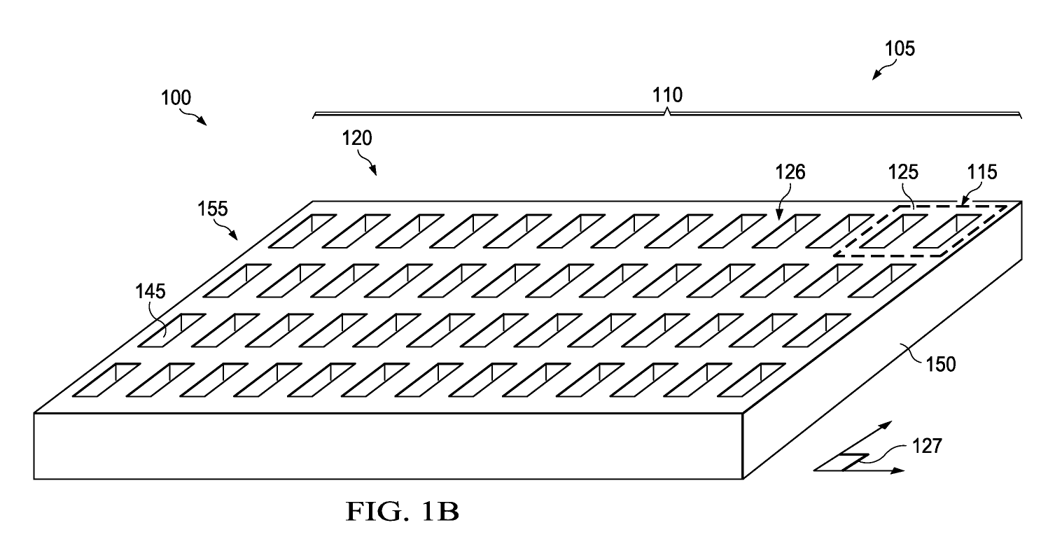

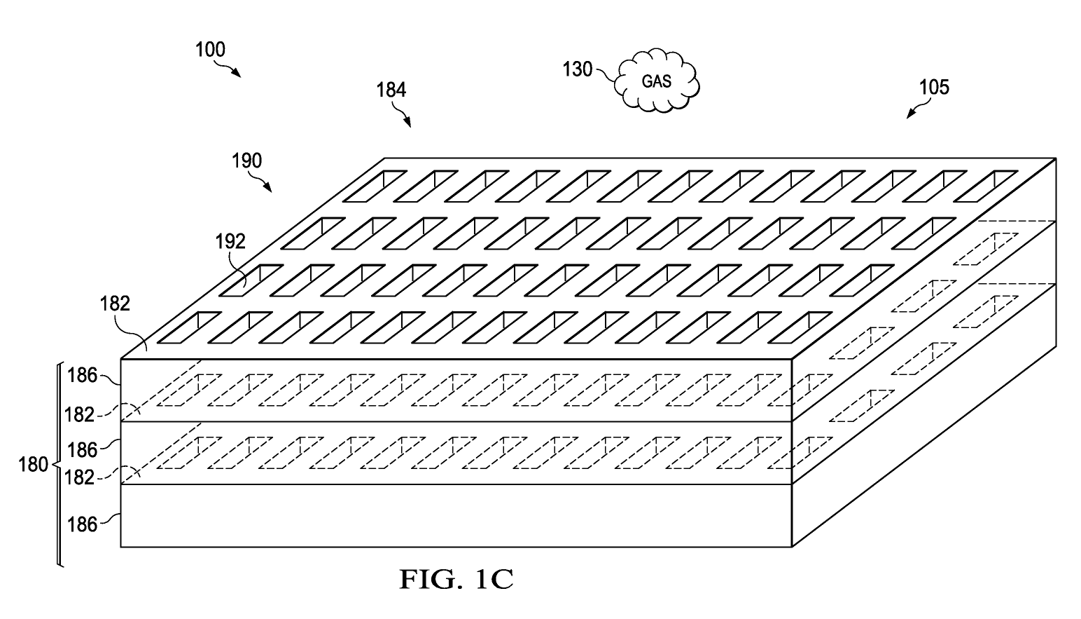

One embodiment of the disclosure is an apparatus configured as an optical system. The optical system can be manufactured and used according to any of the methods described herein. FIGS. 1A and 1B show perspective views of two example apparatus configured as optical systems 100, and, a metamaterial optical component 105 that forms a portion of these systems 100. Embodiments of the optical system 100 can be configured as a sensor system, an optoelectronic system or a wireless transmission system, or, other optical systems well know to those skilled in the art. The metamaterial optical component 105 can be configured as one or more optical components of the system 100, for example, as a lens, a refractive structure, converter, modulator, distortion filter, or, sensor component.

The metamaterial optical component 105 includes an array 110 of unit cells 115. At least one, and in some cases substantially all, of the unit cells 115 have one or more patterns 120 of electrically conductive flexible polymers 125. The one or more patterns 120 are configured to provide the metamaterial optical component 105 with a negative index of refraction. An optical property of the metamaterial optical component 105 can be changed by flexing the metamaterial optical component 105.

The term flexible polymer as used herein means that the optical component 105 includes, or is made of a flexible polymer, such that the component 105 is capable of being folded or bent from its originally assembled shape without breaking. For instance in some embodiments, the metamaterial optical component 105 can be flexed laterally in an assembly plane 126 by a bend angle 127 of at least about 5 degrees, and in some case at least about 25 degrees. Similar extents of flexing could be done above or below a flexible assembly plane 126. In some cases, for example, such as when the conductive polymer is an elastic polymer, after the flexing force is removed, the optical component 105 can substantially return to its originally assembled shape.

In some embodiments, the optical property that is changed by flexing the metamaterial optical component 105 is one or more of a focal length, an electromagnetic radiation receiving surface 128 of the component 105, or, or electromagnetic radiation transmitting surface 129 of the component 105. By changing one or both of the receiving or transmitting surfaces the path of the source electromagnetic radiation can be re-directed.

In some embodiments, the electrical conductivity of the conductive flexible polymers 125 can be increased or decreased by exposure to a gas 130. For example, in some cases, exposure to the gas 130 changes the conductivity by at least about 10 percent as compared to the conductivity of the polymers 125 not exposed to the gas 130.

A consequence of changing the electrical conductivity of the polymer 125 is that an optical property of the metamaterial optical component 105 is changed as compared to before exposure to the gas 130. The optical property that is changed can be the negative index of refraction. For instance, exposing the polymer 125 to the gas 130 can result in a change the real or imaginary parts, or both parts, of the index of refraction of the metamaterial optical component 105 with respect to a source wavelength of electromagnetic radiation 135 (shown as being emitted from a source 137 in FIG. 1A) passed through the metamaterial optical component 105. In other cases, the optical property that is changed is a transmittance of the electromagnetic radiation 135 passed through the metamaterial optical component 105. For example, the intensity of electromagnetic radiation 135 passed through the metamaterial optical component 105 can be increased or decreased as compared to its intensity passed through the metamaterial optical component 105 before the polymer 125 is exposed to the gas 130. The electromagnetic radiation 135 can be of one or more specific wavelengths in the visible to microwave range, or other wavelengths useful in sensor, optoelectronic, or telecommunication systems.

As illustrated for the embodiment in FIG. 1A, in some cases, the pattern 120 includes a first pattern 140 and a second pattern 142. Each unit cell 115 of the array 110 includes one of the first pattern 140 and one of the second pattern 142. The first pattern 140 is configured so as to provide the metamaterial optical component 105 with a negative permittivity (ε) with respect to the source wavelength of electromagnetic radiation 135. The second pattern 145 is configured to provide the metamaterial optical component 105 with a negative permeability (μ) with respect to the source wavelength 135.

Alternatively, as illustrated for the embodiment in FIG. 1B, in some cases, the pattern 120 includes or is a single pattern arranged so as to provide the metamaterial optical component 105 with both a negative ε and μ with respect to the source wavelength of electromagnetic radiation 135. In this case, each unit cell 115 of the array 110 includes one of the single patterns 120.

As well know to those skilled in the art, when both ε and μ are negative, then the metamaterial optical component 105 can have a negative refractive index. In still other cases, the metamaterial 105 can have a negative index of refraction without both ε and μ being negative.

As further illustrated in FIGS. 1A and 1B, the metamaterial optical component 105 can further include an insulator 150. In some cases, the insulator 150 can be made of a rigid material, such as glass, sapphire or quartz. In other cases, the insulator 150 can be made of a flexible material, such as a flexible organic dielectric material. Example material include polyethylene, polypropylene, Teflon® or other thermoplastic or thermoset polymers. A flexible insulator 150 has the advantage of permitting a larger range of flexibly of the metamaterial optical component 105 without breaking the component 105. For instance, for the embodiment shown in FIG. 1B the bend angle 127 can be above or below the non-flexed assembly plane 126 of the insulator 150, and the both the flexible polymer 125 and insulator 150 are bent together.

As shown in FIG. 1A, the first pattern 140 of conductive flexible polymers 125 can be separated from the second pattern 142 of conductive flexible polymers 125 by a layer of insulator 150. The first and second patterns 140, 142 can be located on different sides 155, 157 of the insulator 150. In other cases, such as shown in FIG. 1B, the single pattern 120 can be located on one side 155 of the layer of insulator 150. Individual ones of the single pattern 120 of conductive polymers 125 are separated by the insulator 150. In still other cases, however, there can be two or more different patterns (not shown) of conductive polymer 125 on the same side 155 of the layer of insulator 150.

In some cases, as shown in FIG. 1A, the insulator 150, and the one or more patterns 120 of conductive polymers 125, can form a three-dimensional array 110 of unit cells 115. For instance, some of the layers of insulator 150 that the patterns 120 are located on can be coupled to a base layer 160, or to other layers of insulator 150, to form the three-dimensional array 110. To permit a greater range of flexibility of the component 105, it is preferable for the base layer 160 to be made of a flexible material. For example, the base layer 160 can be made of a flexible organic dielectric material, such as described above for the insulator layer 150.

In other cases, as shown in FIG. 1B, the insulator 150 and one or more patterns 120 of conductive polymers 125 can form a two-dimensional array 110 of unit cells 115. For instance, the pattern 120 of conductive polymers 125 can be located in substantially the same plane as the layer of insulator 150.

In some cases, the one or more patterns 120 are all composed of the same type of electrically conductive flexible polymers 125. In other cases, one pattern (e.g., one of first or second patterns 140, 142, FIG. 1A) is composed of conductive flexible polymers 125 of a first type, and another pattern (e.g., the other one of first or second patterns 140, 142, FIG. 1A) is composed of conductive flexible polymers 125 of a second type. The first and second types of conductive flexible polymers have different molecular formulas.

In still other cases, one or more of the patterns 120 further includes a metal. For instance, one pattern (e.g., one of first or second patterns 140, 142, FIG. 1A) is composed of conductive flexible polymers 125 and another pattern (e.g., the other one of first or second patterns 140, 142, FIG. 1A) can be composed of a metal. Or, a portion of the one or more patterns 120 can be composed of metal, and, the remaining portion composed of the conductive flexible polymer 125.

One skilled in the art would be familiar with the variety of configurations of patterns 120 that could be used to provide the metamaterial optical component 105 with a negative index of refraction at a desired wavelength of electromagnetic radiation 135.

For some example embodiments, as shown in FIG. 1A, one pattern 140 can be a split-ring resonator pattern (e.g., double, balanced or U-shaped split-ring resonator) and another pattern 142 can be parallel lines. In other example embodiments, as shown in FIG. 1B, the single pattern 120 can be a fish-net structure. For example, an array of holes 145 can be formed in a layer of the flexible polymer 125 to form the fish-net structure or other pattern 120. Soukoulis et al. (Science 314:47-49, 2007), incorporated herein in its entirety, gives further examples of possible patterns.

In other cases, the pattern 120 can includes an anisotropic material comprising the conductive flexible polymer 125. The term anisotropic materials as used herein are materials having a single resonance and an optical characteristic such as anisotropy or chirality that produces a negative index of refraction. Hoffman et al., (Nature Materials published on line 14 October 2007;doi:10.1038/nmat2033), incorporated herein in its entirety, gives examples of metamaterials comprising anisotropic material made of metal. In the present disclosure the pattern 120 can include interleaved layers of different types of conductive polymers 125 that form the anisotropic material.

One skilled in the art would be familiar with the different electrically conductive flexible polymers 125 that could be used to form the metamaterial optical component 105. The term electrically conductive polymer as used herein refers to an organic molecule having repeating monomer units, a molecular weight of at least about 1000 gm/mole, and an electrical conductivity of at least about 1 S/cm.

Non-limiting examples of electrically conductive flexible polymers 125 include polyacetylene; polyaniline; polypyrrole; polythiophene; poly(3-alkylthiophene); polyphenylenesulphide; poly(phenylene sulphide-phenyleneamine); polyphenylene-vinylene; polythienylene-vinylene; polyphenylene; polyisothi-anaphthene; polyazulene; and polyfuran. Kumar et al. (Eur. Polym. J. 34:1053-66 1998) and Janata et al., (Nature Methods 2:19-24 2002), both incorporated herein in their entirety, gives examples of electrically conductive polymers. Embodiments of the electrically conductive flexible polymers 125 include blends or copolymers of these or other electrically conductive flexible polymers, or, blends with non-conductive flexible polymers. Embodiments of the electrically conductive flexible polymers 125 can include dopants to increase the polymer's conductivity and/or to stabilize the polymer. Non-limiting examples include I₂, B₂Li, Na, AsF₃, BF₄—, ClO₄—, FeCl₄—, AsF₅, Li, K, HCl. One skilled in the art would be familiar with other types anions, oxidizing agents or reducing agents that could serve as dopants.

As noted above, exposing the polymers 125 to the gas 130 can change their electrical conductivity. The term gas as used herein refers to molecules or atoms in a gaseous state. The term gas also includes a vapor of liquid droplets of such molecules or atoms, suspended or floating in air or in other gases. The gas 130 can react with the polymer 125 such that the conductivity increases or decreases. The reaction can include binding the molecules or atoms of gas 120 to the polymer 125 in covalent or non-covalent interactions or covalent modifications to the polymer 125.

In some cases, the conductivity change is reversible. That is, upon the subsequent removal of the gas 130, the electrical conductivity of the conductive flexible polymer 125 returns to its pre-exposure value. For instance, the atoms or molecules of the gas 130 can interact with the polymer 125 so as to changes the conformation of the polymer 125 such that its electrical conductivity changes. In some cases, when the gas 130 is removed (or the polymer removed from the gas) the polymer 125 can return to its original conformation and conductivity. In other cases exposure to the gas 130 causes a change in conductivity that is not reversed when the gas 130 is removed.

Embodiments of the gas 130 include organic gases or inorganic gases. Non-limiting example organic gases include methanol, chloroform, dichloromethane, isopropanol, hexane, or combinations thereof. Non-limiting example inorganic gases include HCl vapor or I₂ gas.

In some embodiments, the metamaterial optical component 105 can be used as a sensor component in a sensor system 100. In some cases, the change in optical property of the metamaterial optical component 105 can be used to sense the presence or absence, or change in concentration, of the gas 130. For example when the conductivity of the flexible polymer 125 is changed by exposure to the gas, the negative index of refraction of the metamaterial optical component 105 can change by becoming more negative or less negative, and in some cases, a positive index of refraction. Consequently, a source electromagnetic radiation 125 can become refracted towards or away from the normal 165 of the interface between the metamaterial optical component 105 and the medium that the electromagnetic radiation 135 was traveling in before contacting the metamaterial optical component 105. As another example, the intensity of the source 135 can be increased or decreased as a consequence of the change in optical property. In either of these examples, the extent of change in refractive index or intensity of the output electromagnetic radiation 170 can be calibrated with respect to gas 130 concentration, to facilitate the component's 105 use as a gas sensor.

The metamaterial optical component 105 can be used as an optical module in an optoelectronic system 100. The optoelectronic system 100 can be an optical fiber communication system having a plurality of optical fiber spans and optical modules that connect adjacent one of the optical fiber spans. The metamaterial optical component 105 can be at least one of the optical modules that is configured to modify a source signal of electromagnetic radiation 135. For example the metamaterial optical component 105 can be configured to amplify or attenuate specific wavelengths of electromagnetic radiation 135 so as to correct linear or nonlinear distortions in the wavelengths.

In still other embodiments, the metamaterial optical component 105 can be used as a component of a wireless communication system 100. For example the metamaterial optical component 105 can be used as a refractive structure that re-directs the source electromagnetic radiation 135 to a target receiver 175 of the wireless transmission system 100.

FIG. 1C show perspective views of another example apparatus 100 comprising an optical component 105. Similar to that discussed above, in some cases, the optical component 105 can form a portion of the apparatus configured as a sensor system. In some cases, the optical component 105 is part of the apparatus 100 configured as an optoelectronic system or wireless transmission system.

The optical component 105 has a stack 180 of layers 182 of electrically conductive flexible polymers, the stack being a metamaterial. In some embodiments, a refractive surface 184 of the optical component 105 is deformable by flexing the stack 180. The deformation is sufficient to case an significant change a optical property of the component 105. In some cases, for example, the refractive angle of the optical component 105 changes by at least about 2 percent, and more preferably, at least about 5 percent, as compared to the non-deformed component 105. In some embodiments, the stack 180 is deformable to vary a focal length of the optical component 105.

In some embodiments, the stack comprises layers 186 of flexible organic dielectrics, the layers 186 of organic dielectric and the layers of conductive polymer 182 alternating in the stack 180. The layers 186 of organic dielectric can be made of the same material as the insulator layers 150 (FIG. 1A-1B).

In some cases, the stack 180 is a metamaterial at a wavelength of near infrared light or visible light. In some cases, the stack 180 is a metamaterial at a wavelength of near microwaves.

The layers 182 of electrically conductive flexible polymers can be composed of any of the polymers discussed above in the context of FIGS. 1A and 1B. As similar to that discussed above, in some cases, an electrical conductivity of the conductive flexible polymers can be increased or decreased by exposure to a gas 130 (e.g., organic or inorganic gases).

In some embodiments, the stack 180 has both a negative electrical permittivity and a negative magnetic permeability in a wavelength range of electromagnetic radiation over which the stack 180 is a metamaterial. In some embodiments a first pattern 190 (e.g., one of the patterns discussed in the context of FIG. 1A-1B) of resonators of conductive flexible polymer provides the stack 180 with a negative permittivity in this wavelength range and a disjoint second pattern 192 (e.g., a different one of the patterns discussed in the context of FIG. 1A-1B) of resonators provides the stack 180 with a negative permeability in this wavelength range. Similar to that discussed in the context of FIG. 1A, in some cases, the first pattern 190 can be composed of conductive flexible polymers of a first type, and the second pattern 192 can be composed of conductive flexible polymers of a second type, and, the first type of conductive flexible polymers has a different molecular formula than the second type of conductive flexible polymers. In some cases wherein one the first pattern 190 or the second pattern 192 further includes a metal. In some cases, the first pattern 190 comprises parallel lines, and the second pattern 192 comprises a split ring resonator. In some cases, one or both of the first pattern 190 or the second pattern 192 of conductive flexible polymers includes an anisotropic material comprising the conductive flexible polymer.

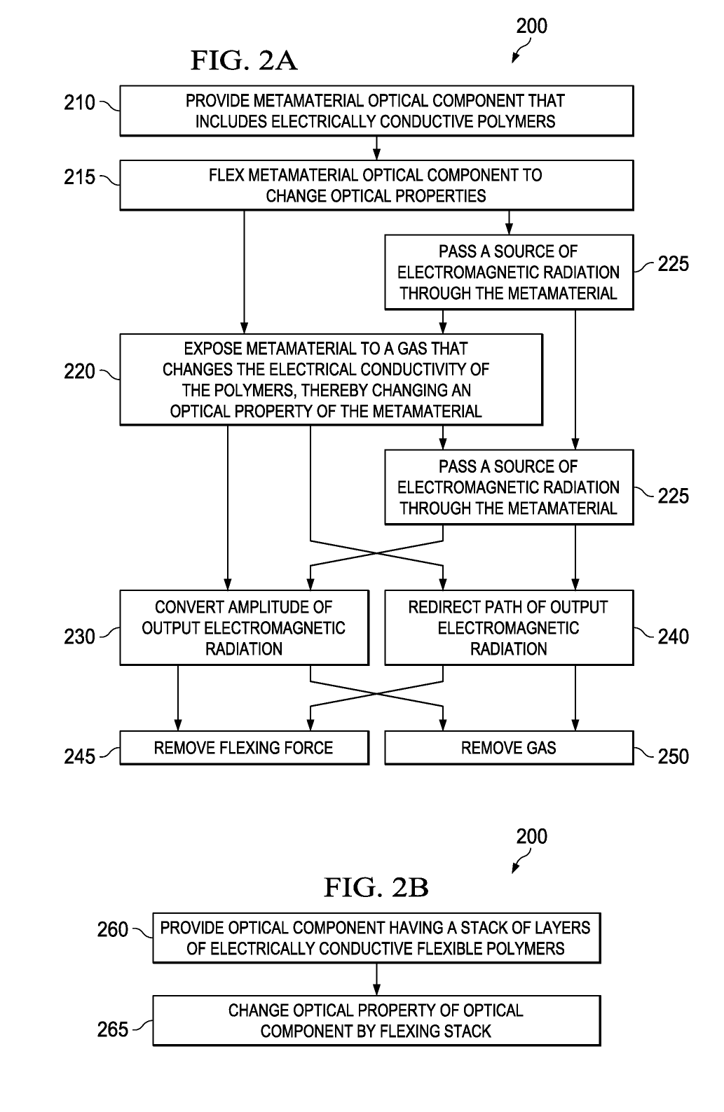

Another embodiment of the disclosure is a method of using an optical system. FIG. 2A presents a flow diagram of selected steps of an example method of use 200. Any embodiments of the apparatuses 100 described herein, such as in the context of FIGS. 1A and 1B, can be used in the method 200. With continuing reference to FIG. 1A, the metamaterial optical component 105 is provided in step 210. In step 215 an optical property of the metamaterial optical component 105 is changed by flexing the metamaterial optical component 105.

In some embodiments, in step 220, the metamaterial optical component 105 is exposed to a gas 130 that causes a change in electrical conductivity of the flexible polymers 125, thereby changing an optical property of the metamaterial 105 as compared to before exposure to the gas 130.

Some embodiments include a step 225 of passing a source of electromagnetic radiation 135 through the metamaterial optical component 105. The source electromagnetic radiation 135 can be passed through the metamaterial optical component in step 225 before, during or after flexing (step 215) or exposure to the gas (step 220). At some stages of the method 100, the source electromagnetic radiation 135 may be passed through the metamaterial optical component 105 that is not flexed or that is not exposed to the gas 130.

In some cases, flexing the metamaterial optical component 105 in step 215, or, exposing the metamaterial optical component 105 to the gas 130 in step 220 converts (step 230) the source electromagnetic radiation 135 to an output electromagnetic radiation 170 having a different amplitude than the source electromagnetic radiation 135. In other cases flexing or exposing the metamaterial optical component to the gas in steps 215 and 220, respectively, re-directs (step 240) the path of the source electromagnetic radiation 135. That is, the path of the output electromagnetic radiation 170 has a different direction than it would have if the metamaterial optical component 105 was not flexed or was not exposed to the gas 130.

In some cases, the change in optical property associated with flexing in step 215, or, exposing to the gas 130 in step 220 causes a permanent change in the metamaterial optical component's 105 optical property. In other cases, the change in optical property is reversible by performing a step 245 to removing the flexing force, or, a step 250 to remove the gas 130 from the vicinity of the metamaterial 105.

FIG. 2B presents a flow diagram of selected steps of a second example method of use 200. Any embodiments of the apparatuses 100 described herein, such as in the context of FIG. 1C, can be used in the method 200. With continuing reference to FIG. 1C, the method 200 comprises a step 260 of providing a optical component 105 having a stack 180 of layers 182 of electrically conductive flexible polymers, the stack 180 being a metamaterial. The method further comprises a step 265 of changing an optical property of the optical component 105 by flexing the metamaterial optical component 105. In some cases the method 200 further includes exposing the optical component 105 to a gas 130 that causes a change in a conductivity of the conductive flexible polymers, thereby changing an optical property of the optical component 105 as compared to before exposure to the gas 130.

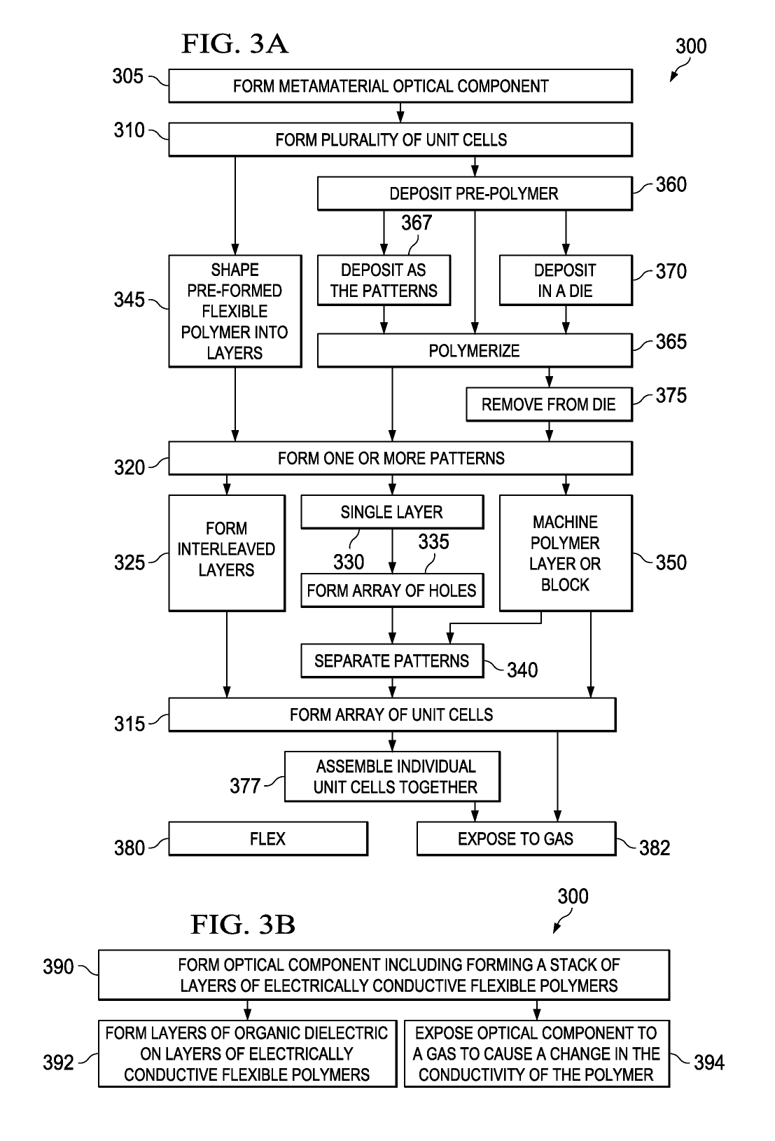

Another embodiment of the disclosure is a method of manufacture. FIG. 3A presents a flow diagram of selected steps of an example method 300. Any embodiments of the apparatuses 100 described above in the context of FIGS. 1A, 1B and 2, can be manufactured by the method 300.

Again, with continuing reference to FIG. 1A, the method 300 includes a step 305 of forming a metamaterial optical component 105. Forming the component (step 305) includes a step 310 of forming a plurality of unit cells 115 and a step 315 of forming an array 110 of the unit cells 115.

Forming the unit cells 115 (step 310) includes a step 320 of forming one or more patterns 120 from electrically conductive flexible polymers 125 for each of said unit cells. As discussed previously herein, the patterns 120 are configured to provide the metamaterial 105 with a negative index of refraction.

In some cases, forming the one or more patterns 120 in step 320 includes a step 325 of forming interleaved layers of different types of conductive flexible polymers 125 to form an anisotropic material that can serve as the metamaterial optical component 105.

In other cases, forming the one or more patterns 120 in step 320 includes forming in step 330 of forming a single layer of conductive flexible polymer 125, and then forming in step 335, an array of holes 145 in the flexible polymer layer 125. The array of holes can form a single pattern 120 (e.g., a fish-net structure, FIG. 1B), or multiple different patterns, if needed, to achieve the desired negative index of refraction. The holes 145 can be formed mechanically using tools to cut or punch-out portions of the polymer layer, or, using conventional chemical or laser etching tools.

In some cases similar tools are used to separate the patterns into individual unit cells (step 340), if desired. In other cases, the single pattern 120 forms a continuous structure.

In some cases, for either step 325 or step 330, the flexible polymer layer or layers can be provided as a preformed polymer (e.g. a commercially supplied polymer) that is then shaped in step 345 to form the layer or layers, for example, using conventional polymer processing techniques such as melt extrusion. The layer or layers can then used in the next steps in the method 300, e.g., step 335 to form holes in the layer, or, laminated to other layers of conducting polymer 125 in step 325 to form the interleaved layers of polymers.

In other cases, for either step 325 or step 330, a preformed layer or block of the flexible polymer 125 can be machined in step 350 to form the patterns 120. For example two-dimensional or three-dimensional excimer laser micro machining, or, other types of photochemical or mechanical machining can be performed to form the pattern 120.

In still other cases a pre-polymer can be deposited as a uniform coating in step 360 on a surface (e.g., on the insulation layer 150 or a sacrificial layer not retained as part of the metamaterial optical component) and then polymerized in step 365 using, e.g., conventional forms of heat, light or chemical activation, either after or during the deposition of the pre-polymer.

In other cases, instead of depositing a uniform coating or pre-polymer, the pre-polymer is deposited in step 367 as the pattern or patterns 120. For example, an ink jet printer can be used to deposit the pre-polymer in the desired pattern 120, and polymerized in accordance with step 367.

In still other cases, the pre-polymer of the flexible polymer can be deposited in a die in step 370. The die can have a cavity whose shape matches the pattern or patterns 120. The pre-polymer can be then be polymerized (step 365) and then removed from the die (step 375) to provide the flexible polymer 125 which has been cast into the shape of the desired pattern 120.

In some cases forming the array 110 of unit cells 115 in step 315 includes a step 377 of assembling individually formed unit cells 115 together. For example, individual patterns 120 of the flexible polymers 125 or the patterns on an insulator layer 150 can be adhered to a base layer 160 using glue or thermal welding in to form a three-dimensional array 110. In other cases, however, the array of unit cells 115 is formed in step 315 as part of forming the pattern 120 of polymers 125. For example, a two-dimensional array 110 of unit cells can be formed as part of forming the pattern 120 as part of depositing pre-polymer in step 350 or as part of forming the interleaved layers of polymer 125 in step 325.

In some cases the step 305 of forming the metamaterial 105 can further include a step 380 of flexing the array 110 of unit cells 115, or a step 382 of exposing the array 110 of unit cells 115 to a gas 130. Either or both of these steps 380 or 382 can cause a change in conductivity of the flexible polymer 125, which thereby converts the array 110 of unit cells 115 into the desired metamaterial optical component 105 with the negative index of refraction. The process of flexing or exposing to the gas in steps 380 or 382, respectively, can be similar to that described above in the context of FIGS. 1A and 1B and for steps 215 and 220, respectively (FIG. 2A).

FIG. 3B presents a flow diagram of selected steps of a second example method 300. Any embodiments of the apparatuses 100 described above in the context of FIG. 1C, can be manufactured by the method 300. With continuing reference to FIG. 1C, the method 300 includes a step 390 of forming an optical component 105 including forming a stack 180 of layers 182 of electrically conductive flexible polymers, the stack 180 being a metamaterial. In some cases, the method 300 includes a step 392 of forming layers of organic dielectric 184 on layers 182 of electrically conductive flexible polymers such that each of the layers of organic dielectric 184 alternate with the layers of conductive polymer alternate in the stack 180. In some cases the method 300 further includes a step 394 of exposing the optical component 105 to a gas 130 that causes a change in conductivity of the conductive flexible polymers thereby changing an optical property of the optical component 105 as compared to before exposure to the gas 130.

One skilled in the art would be familiar with the additional steps the method 300 (FIG. 3A or 3B) could further include to complete the manufacture of the various embodiments of the systems described herein.

Although the embodiments have been described in detail, those of ordinary skill in the art should understand that they could make various changes, substitutions and alterations herein without departing from the scope of the disclosure.

1. An apparatus, comprising:
an optical component having a stack of layers of electrically conductive flexible polymers, said stack being a metamaterial.

2. The apparatus of claim 1, wherein a refractive surface of said optical component is deformable by flexing said stack.

3. The apparatus of claim 2, wherein said stack comprises layers of flexible organic dielectrics, said layers of organic dielectric and the layers of conductive polymer alternate in the stack.

4. The apparatus of claim 2, wherein said flexing of said stack causes a refractive angle of said optical component to change by at least about 1 percent.

5. The apparatus of claim 2, wherein said stack is a metamaterial at a wavelength of near infrared light or visible light.

6. The apparatus of claim 2, wherein said stack is a metamaterial at a wavelength of near microwaves.

7. The apparatus of claim 2, wherein said stack is deformable to vary a focal length of said optical component.

8. The apparatus of claim 2, wherein an electrical conductivity of said conductive flexible polymers can be increased or decreased by exposure to a gas.

9. The apparatus of claim 7, wherein said gas is an organic gas or an inorganic gas.

10. The apparatus of claim 2, wherein said stack has both a negative electrical permittivity and a negative magnetic permeability in a wavelength range of electromagnetic radiation over which said stack is a metamaterial.

11. The apparatus of claim 10, wherein a first pattern of resonators of conductive flexible polymer provides said stack with a negative permittivity in said wavelength range and a disjoint second pattern of resonators provides said stack with a negative permeability in said wavelength range.

12. The apparatus of claim 11, wherein said first pattern is composed of said conductive flexible polymers of a first type, and said second pattern is composed of said conductive flexible polymers of a second type, wherein said first type of conductive flexible polymers has a different molecular formula than said second type of conductive flexible polymers.

13. The apparatus of claim 11, wherein one said first pattern or said second pattern further includes a metal.

14. The apparatus of claim 11, wherein one or both of said first pattern or said second pattern of said conductive flexible polymers includes an anisotropic material comprising said conductive flexible polymer.

15. The apparatus of claim 1, wherein said conductive flexible polymers are selected from the group consisting of:
polyacetylene;
polyaniline;
polypyrrole;
polythiophene;
poly(3-alkylthiophene);
polyphenylenesulphide;
poly(phenylene sulphide-phenyleneamine);
polyphenylene-vinylene;
polythienylene-vinylene;
polyphenylene;
polyisothi-anaphthene;
polyazulene; and
polyfuran.

16. The apparatus of claim 1, wherein said optical component forms a portion of said apparatus configured as a sensor system.

17. The apparatus of claim 1, wherein said optical component is part of said apparatus configured as an optoelectronic system or wireless transmission system.

18. A method of using an apparatus, comprising:
providing an optical component having a stack of layers of electrically conductive flexible polymers, said stack being a metamaterial; and
changing an optical property of said optical component by flexing said metamaterial optical component.

19. The method of claim 18, further including exposing said optical component to a gas that causes a change in a conductivity of said conductive flexible polymers thereby changing an optical property of said optical component as compared to before exposure to said gas.

20. A method of manufacture, comprising,
forming an optical component including forming a stack of layers of electrically conductive flexible polymers, said stack being a metamaterial.
